(19) United States
(12) Patent Application Publication
(10) Pub. No.: US 2003/0157889 A1
(43) Pub. Date: Aug. 21, 2003

(54) Wireless mobile device

(76) Inventor: Kazuhiko Yamada, Hyogo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/333,590

(22) PCT Filed: Aug. 20, 2001
(86) PCT No.: PCT/JP01/07133

(51) Int. Cl. H04Q 7/20; H04B 7/24; H04B 5/00

(52) U.S. Cl. 455/41; 455/39; 455/556

(57) ABSTRACT

A request control portion (3) in a radio mobile unit (A) detects a state or a content of reception data, and determines whether or not it is necessary to optimize reception data of a station. If the reception data is determined to be optimized, the request control portion (3) generates request information corresponding to a content of a modification request with respect to a radio mobile unit (B), and the radio mobile unit A adds the generated request information to transmission data for transmission to the radio mobile unit (B). When modification is requested from demodulation data in the request detecting portion (3) in the radio mobile unit (3), the request control portion (3) modifies control for a voice processing portion (40) and an image processing portion (60) corresponding to the request content. Thus, compared to modifying the reception data of the station only with control thereof, extensive optimization of the same can be realized.

### TECHNICAL FIELD

The present invention relates to a radio mobile unit, and more particularly to a radio mobile unit of which representative is a portable telephone.

### BACKGROUND ART

FIG. 10 is a schematic block diagram of a conventional portable telephone. In FIG. 10, a radio portion 1 demodulates a reception signal received by an antenna 8, and modulates a transmission signal to be transmitted to antenna 8. A control portion 10 performs control of the overall portable telephone, and has a sound portion 4, an operation portion 5, and a display portion 6 connected. Sound portion 4 includes a microphone, a speaker, and the like. Operation portion 5 includes operation keys, and display portion 6 includes a liquid crystal display or the like.

In the conventional portable telephone shown in FIG. 10, when data such as a volume or a tone of the received voice and an image quality is in a state different from a desired state, that is, when it is desirable to optimize the state of the received data, a portable phone user needed to modify an appropriate parameter using operation portion 5. In this case, control portion 10 controls sound portion 4 and display portion 6, in response to a provided modification request.

Since the conventional portable telephone is configured in a manner as described above, the reception data can be optimized only at a mobile unit covered by a station by the portable phone user. Therefore, if another station does not transmit data in a state desired by the station, it is difficult to achieve an effect of optimization.

### DISCLOSURE OF THE INVENTION

Accordingly, a main object of the present invention is to provide a radio mobile unit having a function to control data transmitted from another station to optimize reception data of a station by transmitting a request for modifying a transmission data content to the another station, when the data received by a mobile unit covered by the station is not in a desired state.

A radio mobile unit according to the present invention is characterized by including a receiving portion receiving data transmitted from another station, an output portion outputting data received by the receiving portion, a control portion generating modification request information with respect to a state of transmission data from the another station, based on a state of the data received by the receiving portion, and a transmitting portion transmitting the modification request information generated by the control portion to the another station.

Therefore, according to the present invention, since output of an output circuit can be controlled in accordance with a modification instruction from the another station, extensive optimization can be realized, compared to modifying reception data of the station only with control at the station.

A radio mobile unit according to another invention is characterized by including a receiving portion receiving data transmitted from another station, an output portion outputting data received by the receiving portion, a detecting portion detecting a state of audio data to be transmitted to the another station, a control portion generating modification request information with respect to a state of transmission data from the another station, based on a state of data detected by the detecting portion, and a transmitting portion transmitting the modification request information generated by the control portion to the another station.

Thus, audio output can be optimized in accordance with a modification instruction from the another station.

Further, a radio mobile unit according to another invention is characterized by including a receiving portion receiving data transmitted from another station, an output portion outputting data received by the receiving portion, an operation portion setting a state of transmission data from the another station, a control portion generating modification request information with respect to a state of the transmission data from the another station, based on a state of the data received by the receiving portion, and a transmitting portion transmitting the modification request information generated by the control portion to the another station.

Thus, a function to optimize the reception data of the station can be implemented.

Moreover, a radio mobile unit according to another invention is characterized by including a receiving portion receiving data transmitted from another station, an output portion outputting data received by the receiving portion, a state storage portion storing a desired state of the reception data, a control portion generating modification request information with respect to a state of transmission data from the another station, based on a storage content of the state storage portion, and a transmitting portion transmitting the modification request information generated by the control portion to the another station.

In addition, the present invention is characterized in that the data received from the another station by the receiving portion is audio data, and the control portion generates modification request information for modifying a state of a volume or tone of the audio data.

Thus, a receiving volume can be optimized without key operation.

Further, the present invention is characterized in that the data received from the another station by the receiving portion is image data, and the control portion generates modification request information for modifying a state of an image quality of the image data.

Thus, a position, resolution, and brightness of the image on an image output portion can be optimized.

Moreover, a radio mobile unit according to another invention is characterized by including a transmitting portion sending transmission data in a prescribed state to another station, a receiving portion receiving data transmitted from the another station, a detecting portion detecting modification request information from the data received by the receiving portion, and a control portion modifying a state of the transmission data transmitted from the transmitting portion, based on the modification request information detected by the detecting portion.

### BRIEF DESCRIPTION OF THE DRAWINGS

FIG. 1 is a schematic diagram of a radio mobile unit in a first embodiment of the present invention.

FIG. 2 illustrates an example in which radio mobile units shown in FIG. 1 communicate with each other via a base station.

FIG. 3 is a flowchart illustrating an operation of a radio mobile unit A shown in FIG. 2.

FIG. 4 shows a data format of a modification request.

FIG. 5 is a block diagram showing a radio mobile unit in a second embodiment of the present invention.

FIG. 6 is a block diagram showing a radio mobile unit in a third embodiment of the present invention.

FIG. 7 shows a modification request type storage portion, a volume modification content storage portion, a tone modification content storage portion, and an image quality content storage portion contained in a modification content storage portion.

FIG. 8 is a block diagram showing a radio mobile unit in a fourth embodiment of the present invention.

FIG. 9 shows a desired volume state storage portion, a desired tone state storage portion, and a desired image quality state storage portion contained in a desired state storage portion.

FIG. 10 is a schematic block diagram of a conventional radio mobile unit.

### BEST MODES FOR CARRYING OUT THE INVENTION

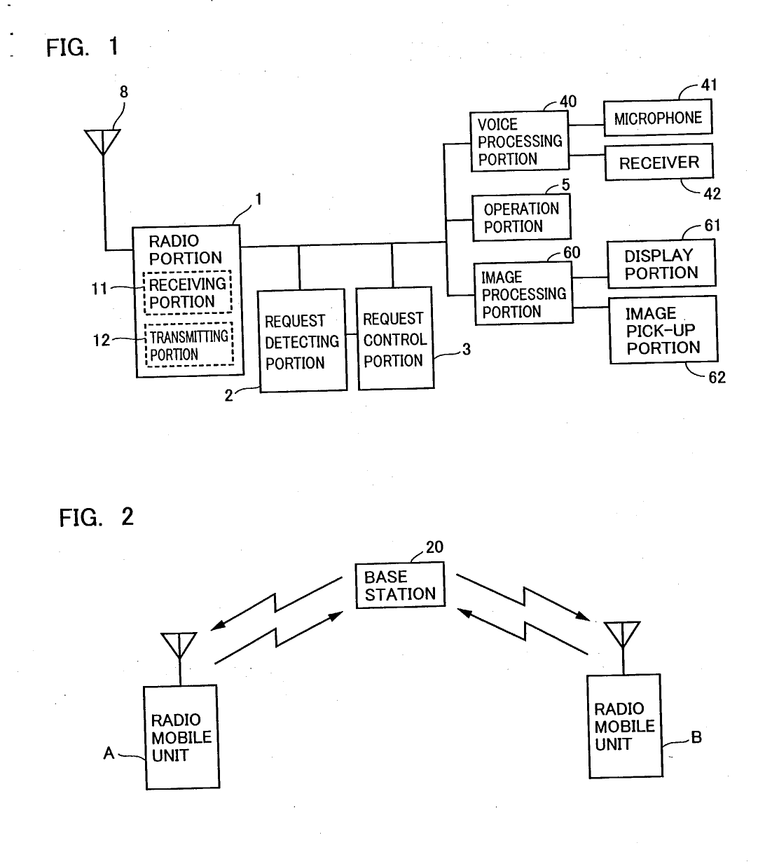

FIG. 1 is a schematic block diagram of a radio mobile unit in a first embodiment of the present invention. In FIG. 1, the radio mobile unit is constituted with a radio portion 1, a request detecting portion 2, a request control portion 3, a voice processing portion 40, a microphone 41, a receiver 42, an operation portion 5, an image processing portion 60, a display portion 61, an image pick-up portion 62, and an antenna 8. Radio portion 1 demodulates a reception signal received by antenna 8, and modulates a transmission signal to be transmitted to antenna 8. Request detecting portion 2 detects modification request information from the another station.

Request control portion 3, in transmission, generates modification request information with respect to the another station in accordance with a state of the station, and in reception, controls voice processing portion 40 and image processing portion 60 based on a modification instruction from the another station, detected by request detecting portion 3. Request detecting portion 2 and request control portion 3 can be implemented by a CPU or a hardware logic. Voice processing portion 40 controls to modify the tone and volume of the voice, and has microphone 41 and receiver 42 connected. Operation portion 5 includes operation keys. Image processing portion 60 controls an image to be displayed and a picked-up image, and has display portion 61 and image pick-up portion 62 connected. Image pick-up portion 62 includes a camera or the like.

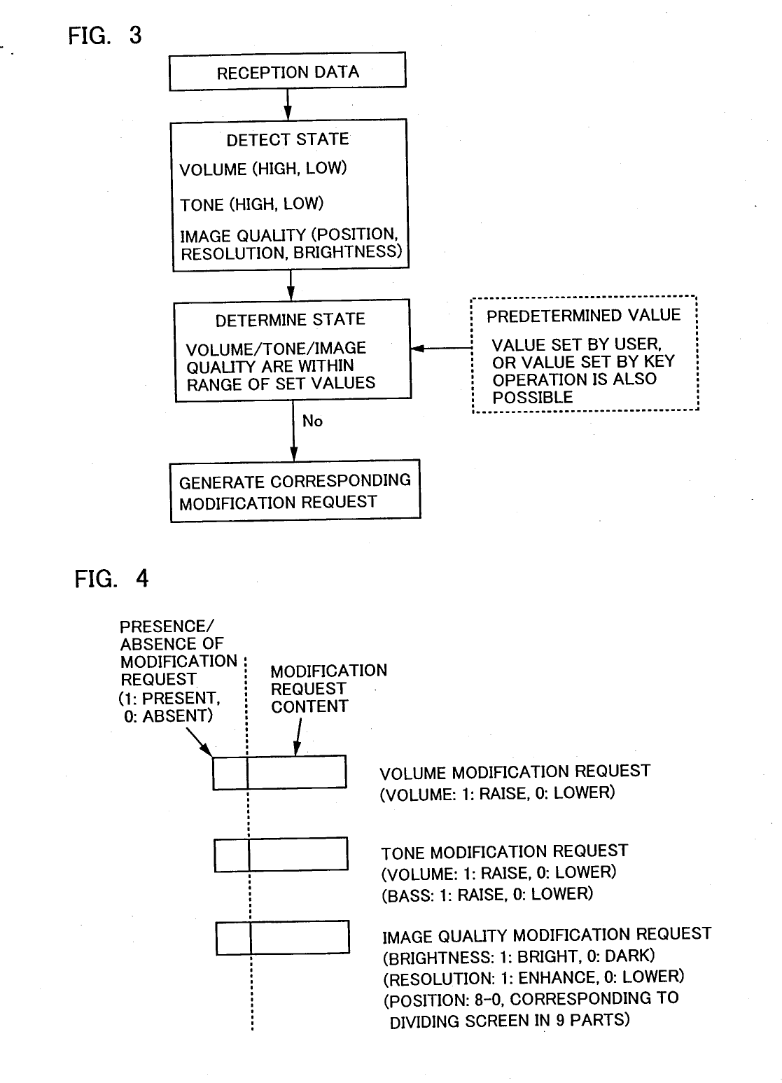

FIG. 2 shows an example in which radio mobile units shown in FIG. 1 communicate with each other via a base station. FIG. 3 is a flowchart illustrating an operation of a radio mobile unit A shown in FIG. 2, while FIG. 4 shows a data format of the modification request.

Referring to FIGS. 1 to 4, an operation in an embodiment of the present invention will be described. For example, when radio mobile units A and B communicate with each other via a base station 20, radio mobile unit A determines whether or not request control portion 3 needs to detect a state or a content of the reception data to optimize the reception data of the station. When request control portion 3 determines that optimization is needed, it generates request information corresponding to the content of the modification request for radio mobile unit B. Then, radio mobile unit A adds the generated request information to the transmission data for transmission to radio mobile unit B.

In radio mobile unit B, request detecting portion 3 detects presence/absence of the modification request from demodulation data. If the modification request from radio mobile unit A is present, radio mobile unit B modifies control of voice processing portion 40 and image processing portion 60, corresponding to the requested content by request control portion 4. Thus, the reception data of radio mobile unit A can be optimized at a time when the reception data is transmitted from radio mobile unit B.

Referring to FIGS. 3 and 4, more specifically, request control portion 3 in radio mobile unit A detects a state of the volume/tone/image quality from the reception data, as shown in FIG. 3. For volume, high and low levels are detected, and for tone, treble/bass levels are detected. In addition, for the image quality, the position, resolution and brightness of an image are detected. When a detected result of the volume/tone/image quality is out of range of predetermined values, request control portion 3 generates a corresponding modification request. Here, the predetermined value may be a fixed value set by a user, or a value set via key operation.

The data format of the modification request consists of presence/absence of the modification request, and a modification request content, as shown in FIG. 4. Presence/absence of the modification request is the information indicating necessity for modification for each of parameters, that is, the volume/tone/image quality. The modification request content includes, for example, increase/decrease of the volume, raising/lowering of the treble and bass level, increase/decrease of brightness, and enhancing/lowering of the resolution.

The modification request thus generated in radio mobile unit A is transmitted from the same to radio mobile unit B. Radio mobile unit B detects the modification request from the reception data, and modifies control of the volume/tone/image quality based on the modification request content.

As described above, according to the present embodiment, if it is determined that the reception data of the station needs to be optimized in either one of radio mobile units A or B, request information corresponding to the modification request content is generated and added to the transmission data for transmission. On the other hand, if it is determined that the modification request is present, control for modification corresponding to the requested content is performed. Thus, the output can further be optimized, compared to adjusting the reception data only at the station. In other words, the volume and the tone in voice processing portion 40 as well as the position, resolution, and brightness of the image displayed on image processing portion 60 can be optimized.

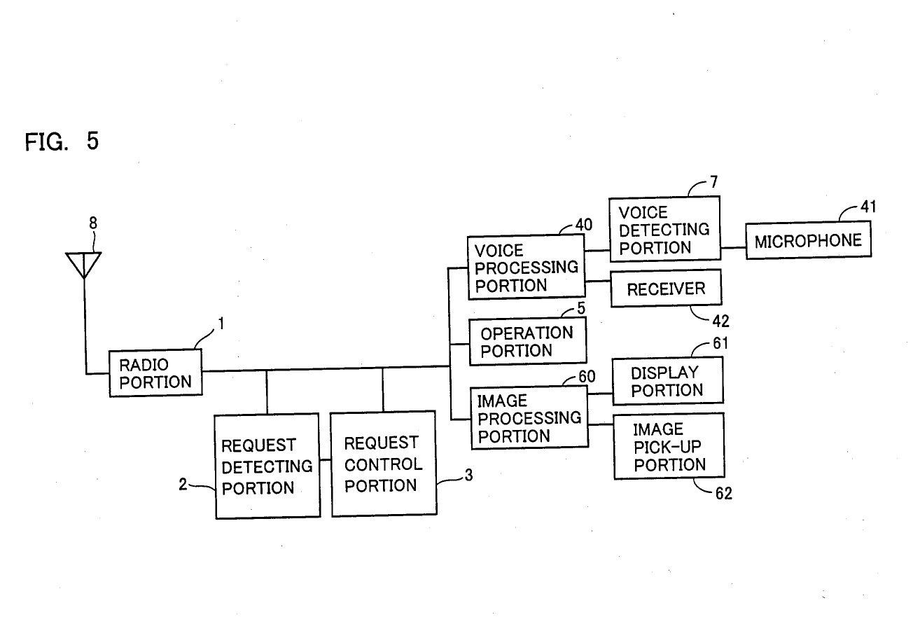

FIG. 5 is a block diagram showing a radio mobile unit in a second embodiment of the present invention. In FIG. 5, a voice detecting portion 7 is added to the embodiment shown in FIG. 1. When it is hard to hear the voice of a party on another end, that is, when the receiving volume is low, generally, the voice level of the user will be higher. Utilizing this, by detecting the output of voice processing portion 40, voice detecting portion 7 measures the voice level of the radio mobile unit user. Based on the measurement result, voice detecting portion 7 generates the modification request for a transmission voice level with respect to the another station.

Thus, the voice level of the user of the station can be used for controlling the another station. For example, in radio mobile unit A, the voice level of the user input from microphone 41 is measured by voice detecting portion 7. When the detected voice level is higher than a certain threshold value, request control portion 3 in radio mobile unit A generates modification request information for raising the transmission voice level with respect to radio mobile unit B, and adds the information to the transmission data to the same. Radio mobile unit B detects the modification request information contained in the demodulation data, and based on the content thereof, modifies the transmission volume setting for voice processing portion 40. Thus, radio mobile unit A can optimize the receiving volume during the communication without any operation. Here, voice detecting portion 7 may detect background noise, and if the level thereof is high, it may raise the transmission level of the another station.

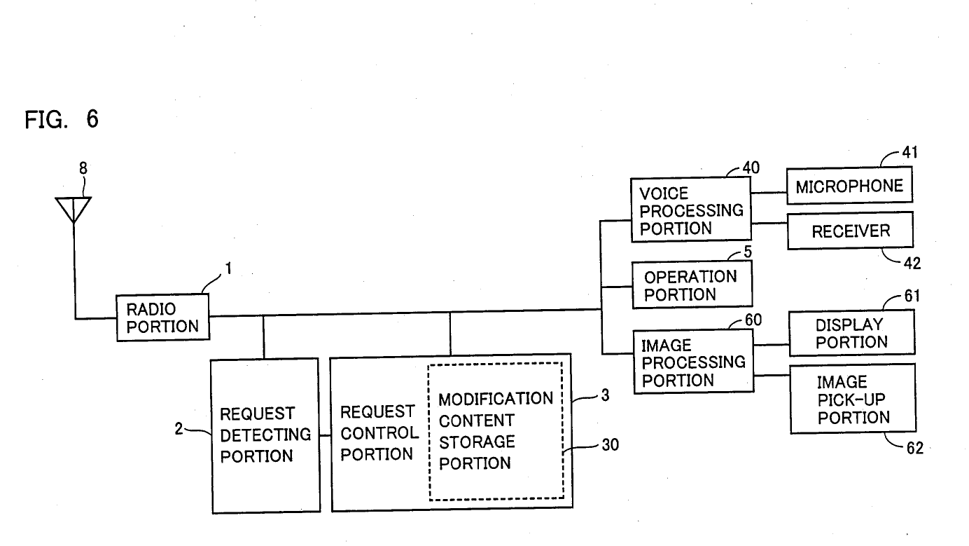

FIG. 6 is a block diagram showing a radio mobile unit in a third embodiment of the present invention. In this embodiment, the modification request with respect to the another station is generated based on the input via key operation by the radio mobile unit user, using operation portion 5. In this case, the key operation by the user of the station is performed for controlling the another station. If the user of radio mobile user A wants to modify a state of current reception data, the user can modify the setting of corresponding parameter with the operation key.

In this case, radio mobile unit A generates the modification request information with respect to radio mobile unit B based on a content recognized at operation portion 5, and adds the information to the transmission data to radio mobile unit B. Radio mobile unit B detects the modification request information contained in the demodulation data, and based on the content thereof, modifies the control for voice processing portion 40 and image processing portion 60. Thus, the user of radio mobile unit A can optimize the reception data at a time when the reception data is transmitted from radio mobile unit B.

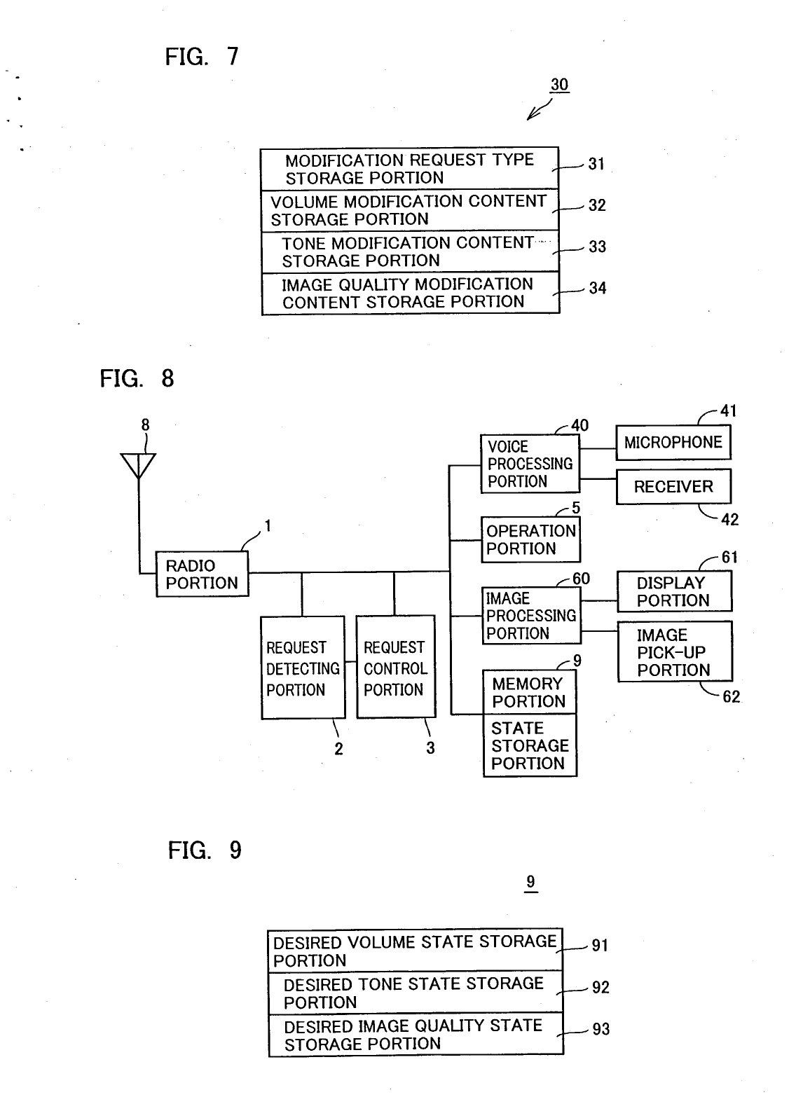

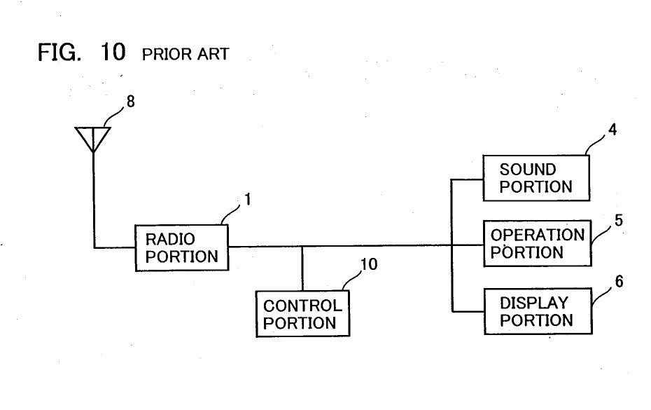

More specifically, the volume/tone/image quality are used as parameters, which can be modified by the user with operation portion 5. As shown in FIG. 7, request control portion 3 contains a modification content storage portion 30 including a modification request type storage portion 31, a volume modification content storage portion 32, a tone modification content storage portion 33, and an image quality content storage portion 34. For example, in order to raise the receiving volume during communication, volume of a modification request type is selected using operation portion 5. In modification request type storage portion 31, the content of the operation keys corresponding to the volume/tone/image quality is stored.

A specific modification request content is then selected. In volume modification content storage portion 32, the content of the operation key in increasing/decreasing the volume is stored. Similarly, in tone modification content storage portion 33, the content of the operation key corresponding to raising/lowering of the treble/bass level is stored. In addition, in image quality modification content storage portion 34, the content of the operation keys corresponding to increase/decrease of brightness and resolution as well as to centering of the image is stored. Request control portion 3 controls to modify these parameters, based on the content stored in modification content storage portion 30.

FIG. 8 is a block diagram showing a radio mobile unit in a fourth embodiment of the present invention. In this embodiment, a desired state of the reception data of the station is stored, and based on the content thereof, the modification request is generated corresponding to the another station. For this purpose, a memory portion 9 storing a desired state of the reception data is added to the configuration shown in FIG. 1.

As shown in FIG. 9, memory portion 9 includes a desired volume state storage portion 91, a desired tone state storage portion 92, and a desired image quality storage portion 93. Desired volume state storage portion 91 stores a desired receiving level, which is divided into 10 stages, for example, so that a certain value thereamong can be selected.

Similarly, desired tone storage portion 92 stores the treble level and the bass level of the receiving sound, of which values are divided into several stages. Desired image quality storage portion 93 stores a desired brightness, resolution, and center position of the image, of which values are divided into several stages respectively.

In such a configuration, the user can set in advance a preferred state of the reception data in memory portion 9 in radio mobile unit A. If it is determined that the state of the reception data is not in the desired state during communication with radio mobile unit B, request control portion 3 in radio mobile unit A generates modification request information with respect to radio mobile unit B based on the desired state stored in memory portion 9, and adds the information to the transmission data to radio mobile unit B. Radio mobile unit B detects the modification request information contained in the demodulated data, and based on the content thereof, modifies the control of sound portion 5 and display portion 7. Thus, the reception data of radio mobile unit A can be optimized to a state set in advance by the user.

### INDUSTRIAL APPLICABILITY

A radio mobile unit according to the present invention generates modification request information with respect to another station, and adds the information to transmission data to the another station for transmission, if reception data of a radio mobile unit of a station is in a state different from a desired state. Accordingly, the data transmitted to the station from the another station is controlled, and the reception data of the station is optimized. Therefore, compared to modifying the reception data of the station only with control thereof, extensive optimization can be realized. The radio mobile unit will thus be useful in a portable telephone.

1. A radio mobile unit, comprising:
a receiving portion (11) receiving data transmitted from another station;
an output portion (40, 60) outputting data received at said receiving portion;
a control portion (3) generating modification request information with respect to a state of transmission data of said another station, based on a state of the data received at said receiving portion; and
a transmitting portion (12) transmitting said modification request information generated by said control portion to said another station.

2. The radio mobile unit according to claim 1, characterized in that the data received by said receiving portion from said another station is audio data, and
said control portion generates modification request information for modifying a state of a volume or tone of said audio data.

3. The radio mobile unit according to claim 1, characterized in that the data received by said receiving portion from said another station is image data, and
said control portion generates modification request information for modifying a state of an image quality of said image data.

4. A radio mobile unit, comprising:
a receiving portion (11) receiving data transmitted from another station;
an output portion (40, 60) outputting data received at said receiving portion;
a detecting portion (2) detecting a state of audio data to be transmitted to said another station;
a control portion (3) generating modification request information with respect to a state of transmission data of said another station, based on a state of the data detected at said detecting portion; and
a transmitting portion (12) transmitting said modification request information generated by said control portion to said another station.

5. The radio mobile unit according to claim 4, characterized in that the data received by said receiving portion from said another station is audio data, and
said control portion generates modification request information for modifying a state of a volume or tone of said audio data.

6. A radio mobile unit, comprising:
a receiving portion (11) receiving data transmitted from another station;
an output portion (40, 60) outputting data received at said receiving portion;
an operation portion (5) setting a state of transmission data of said another station;
a control portion (3) generating modification request information with respect to a state of the transmission data of said another station, based on a state of the data received at said receiving portion; and
a transmitting portion (12) transmitting said modification request information generated by said control portion to said another station.

7. The radio mobile unit according to claim 6, characterized in that the data received by said receiving portion from said another station is audio data, and
said control portion generates modification request information for modifying a state of a volume or tone of said audio data.

8. The radio mobile unit according to claim 6, characterized in that the data received by said receiving portion from said another station is image data, and
said control portion generates modification request information for modifying a state of an image quality of said image data.

9. A radio mobile unit, comprising:
a receiving portion (11) receiving data transmitted from another station;
an output portion (40, 60) outputting data received at said receiving portion;
a state storage portion (30) storing a desired state of reception data;
a control portion (3) generating modification request information with respect to a state of transmission data of said another station, based on a storage content of said state storage portion; and
a transmitting portion (12) transmitting said modification request information generated by said control portion to said another station.

10. The radio mobile unit according to claim 9, characterized in that the data received by said receiving portion from said another station is audio data, and
said control portion generates modification request information for modifying a state of a volume or tone of said audio data.

11. The radio mobile unit according to claim 9, characterized in that the data received by said receiving portion from said another station is image data, and
said control portion generates modification request information for modifying a state of an image quality of said image data.

12. A radio mobile unit, comprising:
a transmitting portion (12) sending transmission data in a prescribed state to another station;
a receiving portion (11) receiving the data transmitted from said another station;
a detecting portion (2) detecting modification request information from the data received by said receiving portion; and
a control portion (3) modifying a state of the transmission data sent from said transmitting portion, based on the modification request information detected by said detecting portion.
